(19) United States
(12) Patent Application Publication
(10) Pub. No.: US 2013/0015965 A1
(43) Pub. Date: Jan. 17, 2013

(54) ALARM HANDLING DEVICE, SURVEILLANCE SYSTEM AND METHOD FOR ALARM HANDLING

(71) Applicants: JOHAN UDD, AKERSBERGA (SE); CHRISTOFFER ÅSTRÖM, LUDVIKA (SE); JONNY SAHLSTRÖM, TYRESO (SE)

(72) Inventors: JOHAN UDD, AKERSBERGA (SE); CHRISTOFFER ÅSTRÖM, LUDVIKA (SE); JONNY SAHLSTRÖM, TYRESO (SE)

(73) Assignee: NYX SECURITY AB, LUDVIKA (SE)

(21) Appl. No.: 13/548,286

(22) Filed: Jul. 13, 2012

(30) Foreign Application Priority Data
Jul. 15, 2011 (SE) 1150704-3

(51) Int. Cl. G08B 23/00

(52) U.S. Cl. 340/501

(57) ABSTRACT

The present disclosure relates to a method for handling alarms in a surveillance system. The method comprises the steps of: in an alarm control unit receiving an input from a surveillance detector device via a first interface; communicating with an alarm input signal control device via a second interface; controlling a state of the alarm signal (L) having at least a first (L=GREEN) or a second (L=RED) state; setting the alarm signal to the second state; presenting an alarm to an operator thereof if the input signal is in the first state whereby the operator handles the alarm signal and a resulting clear alarm signal (STATUS=CLEAR) is sent back to the alarm evaluation and control unit to reset the alarm signal to the first state (L=GREEN).

### CROSS REFERENCE TO RELATED APPLICATION

This application claims the benefit of Swedish Patent Application No. 1150704-3 filed on Jul. 15, 2011, the contents of which are incorporated herein by reference.

### TECHNICAL FIELD

The embodiments described herein relate to an alarm handling device and a surveillance system according to the introductory part of claims 1 and 4 and a corresponding method for alarm handling.

### BACKGROUND

Surveillance systems, also called security systems, are known to include sensor devices such as motion detectors, door sensors and other sensor devices to which surveillance cameras and often monitors are connected. In some surveillance systems, the surveillance camera itself contains a detector, whereas in other systems the camera is triggered by an external detector sensing an event. This, of course can be very costly if also a service person has to be despatched every time there is an alarm trigger signal, irrespective of false or true alarm. Because of that, for surveillance of buildings and other areas, the surveillance cameras typically triggered by events such as objects moving or the like also provide images to the monitors displaying images of the monitored area to security personnel when something unusual occurs, i.e. there is an event to check the validity of the event.

A simple surveillance system can comprise only one camera, but often a plurality of cameras are provided. Typically, the cameras together can provide a plurality of images covering the same surveillance area, often simultaneously to an operator. This requires skilled operators being able to handle much information more or less simultaneously.

Today, there are also surveillance systems, typically being more cost-effective, in which a centrally located surveillance central covering multiple surveillances areas, often for different customers, have operators checking a set of monitors for different customers more or less simultaneously.

Thus, the simultaneous monitoring of several surveillance monitors requires that the operator is skilled in sorting out proper information and being able to handle a large amount of input simultaneously. This may possess problems for instance due to exhaustion of the operator.

Measures have been taken to avoid false alarms in some surveillance systems by means of automatic false alarm detection typically reducing the number of alarm trigger signals sent to the operator.

Sometimes, also one and the same event, which may be false or true, triggers the surveillance camera(s) more than once providing a plurality of alarms for one and the same event. An example can be an object in the form of a plastic bag being transported by a blowing wind providing a plurality of false alarm trigger signals to the camera(s). Similar false alarms trigger signals can occur for instance when snowing, when snow flakes triggers the same camera multiple times giving rise to false alarm signals exhausting the operator since he/she has to evaluate each alarm signal.

Despite the various measures to avoid false alarms, there is still sometimes a stressful situation for the operator which has to evaluate a too large number of alarms for his/her capacity. This of course is a drawback.

Hence, there is a need to overcome at least some of the drawbacks mentioned above.

### SUMMARY

It is an object to provide an alarm handling device, a surveillance system and method for handling alarms, which obviate at least some of the above mentioned drawbacks.

The above stated object is achieved by means of an alarm handling device, a surveillance system and method for alarm handling according to the independent claims.

A first embodiment provides a device for handling alarms in a surveillance system. The device comprises an alarm system control unit having a first, second and third interface. The first interface is configured to communicate and receive an alarm input signal from a surveillance detector device, the second interface is configured to communicate with an alarm input signal control device arranged to control a state of the alarm signal having a first or a second state. The alarm input signal control device is further arranged to provide an alarm to an operator thereof if the input signal is in the first state, by setting the alarm signal to the second state, whereby the operator handles the alarm signal and a resulting clear signal is arranged to be provided back to the alarm system control unit to reset the alarm signal to the first state.

A second embodiment provides a surveillance system, comprising at least one surveillance detector device, at least one surveillance display presenting surveillance information to an operator and a device for handling alarms in a surveillance system. The device comprises an alarm system control unit having a first, second and third interface. The first interface is configured to receive an alarm input signal from said at least one surveillance detector device. The second interface is configured to communicate with an alarm input signal control device arranged to control a state of the alarm signal having a first or a second state. The alarm input signal control device is further arranged to provide an alarm to an operator thereof if the input signal is in the first state, by setting the alarm signal to the second state, whereby the operator handles the alarm signal and a resulting clear signal is arranged to be provided back to the alarm system control unit to reset the alarm signal to the first state.

A third embodiment provides a method for handling of alarms in a surveillance system. The method comprises:
in an alarm control unit receiving an input from a surveillance detector device via a first interface,
communicating with an alarm input signal control device via a second interface,
controlling a state of the alarm signal having at least a first or a second state,
setting the alarm signal to the second state,
presenting an alarm to an operator thereof if the input signal is in the first state whereby the operator handles the alarm signal and a resulting clear signal is arranged to be provided back to the alarm system control unit to reset the alarm signal to the first state.

An advantage of certain embodiments described herein is that they hinder a plurality of alarm trigger signals being produced for an event. Only one alarm trigger signal will be produced for the same event for the same camera.

Problems related to operators having problems with handling a too high number of alarms for his/her capacity will thus be avoided.

Further advantages and features of embodiments of the present invention will become apparent when reading the following detailed description in conjunction with the drawings.

### BRIEF DESCRIPTION OF THE DRAWINGS

FIG. 1 is a schematic block diagram of a surveillance system in which embodiments of this disclosure are implemented.

FIG. 2 is a schematic block diagram of an alarm handling device according to an embodiment of this disclosure.

FIG. 3 is a flow diagram illustrating an embodiment of a method for handling alarms.

### DETAILED DESCRIPTION

The present invention will now be described more fully hereinafter with reference to the accompanying drawings, in which different exemplary embodiments are shown. These exemplary embodiments are provided so that this disclosure will be thorough and complete and not for purposes of limitation.

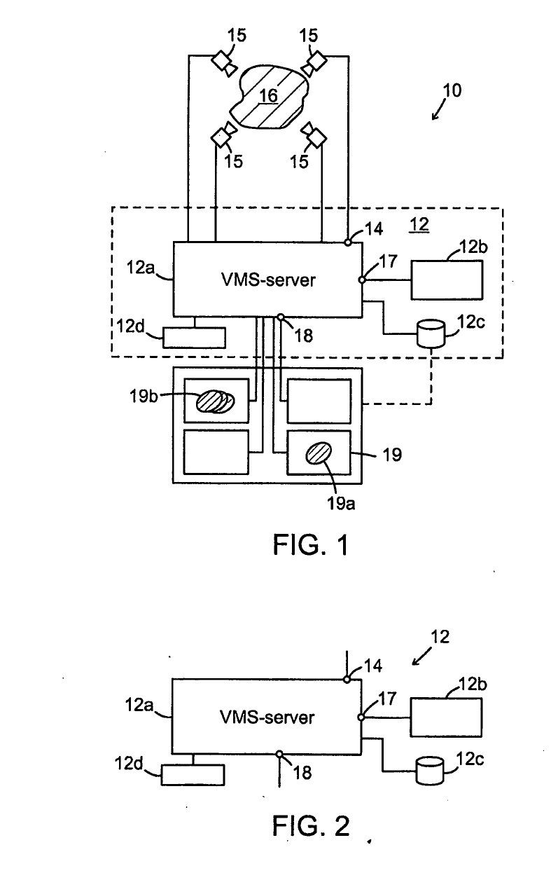

FIG. 1 illustrates an example of a surveillance system comprising an alarm handling device in which embodiments of this disclosure may be implemented.

As illustrated in FIG. 1, the surveillance system 10 comprises a plurality of surveillance detector devices 15, herein four. The surveillance detector devices 15 can be in the form of surveillance cameras, such as CCD-cameras covering an area of surveillance 16. The surveillance system 10 further comprises an alarm handling device 12 (illustrated by a dashed line) for handling alarms. The alarm handling device 12 is connected to, or can communicate with, the surveillance detector devices 15 and a display unit 19, which may comprise a plurality of display sub-units 19a, b, for instance corresponding to the number of cameras 15. For instance, one camera 19a can show a real-time image of the area of surveillance 16, whereas another camera 15 can show a stored sequence of images 19b that has been stored due to an event. The event having triggered the camera(s) 15 can for instance be something unusual that occurred. An example of an event producing a false alarm trigger signal, in the following referred to as “alarm signal” L, is an object in the form of a plastic bag being transported by a blowing wind providing a plurality of false alarm trigger signals to the camera(s). If, for instance, a person climbs over a fence surrounding the area of surveillance 16, a true alarm signal will be produced. In some systems 10, there can be “intelligent” detectors provided which may reduce the number of alarm trigger signals produced by different measures. However, this will not be described in this disclosure.

Herein, the term “alarm signal” includes any item or parameter representing a particular “alarm”.

Herein, the term “event” is referred to as anything that produces an alarm signal L. Typically, an event is something unusual that has happened.

Now is referred to FIG. 2, which illustrates a schematic block diagram of an alarm handling device according to an embodiment of this disclosure.

The alarm handling device 12 comprises an evaluation and control unit 12a for instance implemented in a computer server, such as a Video Management System Server (VMS-server), in which computer programs such as scripts can be implemented by a person skilled in the art of programming. The alarm handling device 12 further typically comprises a first, second and third interface 14, 17, 18, even though interfaces already provided in the VMS-server can also be employed to the extent required. Because of simplicity, only one interface 14, 17 and 18 is illustrated even though it is evident that all cameras 15 are communicating via the first interface 14 etc.

Typically, the evaluation and control unit 12a receives images provided by, or sent from, the surveillance detectors 15, typically cameras, via the first interface 14, evaluates these and finally sends them via the third interface 19 to the display unit 19 monitored by an operator (not shown). Typically, there is also provided an alarm input signal control device 12b, a data base 12c for storing data and/or computer programs, typically scripts for implementing the alarm handling device 12. There is also provided an application unit 12d for handling alarm(s) and event(s). The application unit 12d may contain and provide video management features required including conventional such features, which will not be further described, since they are obvious for the skilled person in surveillance systems and in the art of programming.

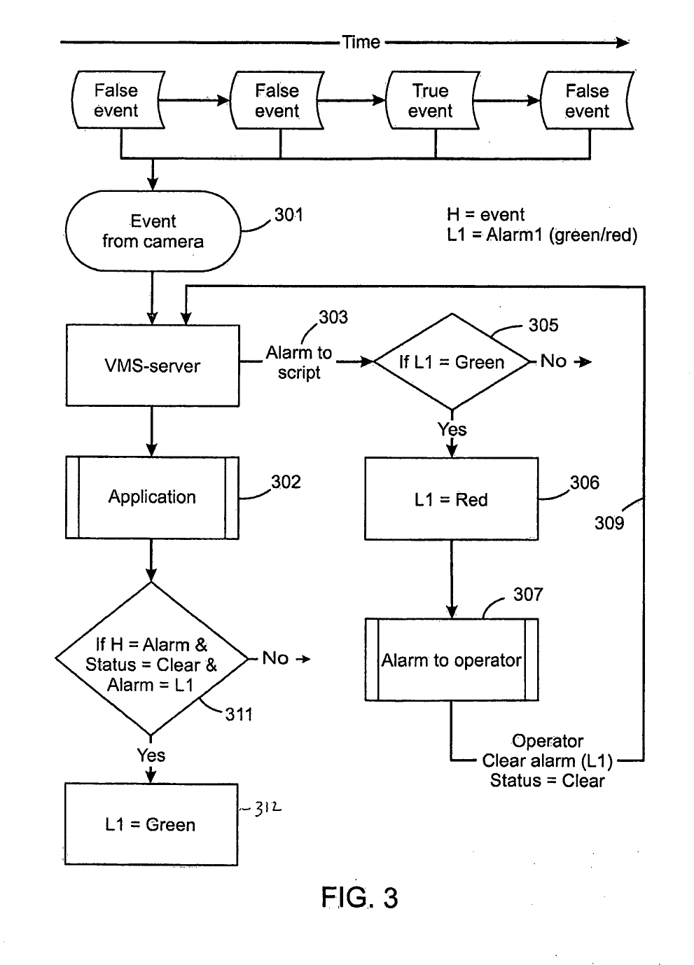

Now is also referred to FIG. 3 illustrating an example of operation according to an embodiment of the present disclosure.

The first interface 14 is configured to receive an alarm input signal from the surveillance detector devices 15, the second interface 17 is configured to communicate with an alarm input signal control device 12b, and the third interface 18 to communicate with the display unit 19 among other units, of which the latter units (not shown in this figure) will be described as follows in more detail.

Now is referred to FIG. 3, which shows a flow diagram illustrating an embodiment of a method.

To start, the evaluation and control unit 12a receives, step 301, an input, in the form of a particular alarm L1 caused by a particular event, from a surveillance detector device 15, in the form of a camera, via the first interface 14. The input may come from a false, or true, event triggering the camera 15, as indicated by a time line in FIG. 3. All events may be false or true even if not illustrated in this particular figure. Also, the number of events is not important. Then, the evaluation and control unit 12a, communicating, step 303, with the alarm input signal control device 12b via the second interface 17, controls, step 305, a state of the alarm signal, herein L1, having at least a first (herein labelled “GREEN”, or a second state, herein labelled “RED” state. The evaluation and control unit 12b is typically implemented by a soft-ware script (SW) in the VMS-server. The alarm signal, L1, herein coming from a first camera 15, is set to the second state, RED, step 306 and is presented, step 307, to the operator thereof if the state of the input alarm signal L1 was in the first state GREEN, in step 305, whereby the operator handles, typically clears, the alarm signal L1 and a resulting clear signal STATUS =CLEAR is sent back, step 309, to the evaluation and control unit (12a) to reset, step 312, the state of the alarm signal L1 to the first state GREEN, provided the operator has cleared the alarm signal L1, step 311.

If, on the contrary, the alarm signal L1 was in the RED state in step 305, or not cleared, step 311, or the alarm signal was not alarm signal L1, or the event was no alarm in fact, no alarm is presented to the operator in step 307. In this way, multiple alarm signals from the same camera 15, for the same alarm signal L1, triggered by the same event will only be presented once to the operator.

If the operator has not cleared the alarm signal, for this particular event, L1 and set STATUS=CLEAR for L1, the state of the alarm signal L1 will not be green, step 311 and 312, and a new alarm from the same camera will not be presented to the operator.

It is also possible, in step 305, to give different priorities to different alarms. Different alarms may for instance have different weights. Information about this may be collected during use. This can be provided with a suitable algorithm.

Alarms L2, L3 etc from other cameras 15 will be handled in the same way as for L1, i.e. the alarm signal status will be controlled and evaluated before presenting any alarm to the operator. An example can be an alarm signal L2 coming from a second camera, which is controlled in step 305, which is in the second state RED, i.e. L2=RED. Then, this alarm signal is not presented to the operator in step 307.

Further, if the operator has not cleared the alarm signal L1, then in step 311, because status in not clear, L1 will not be set to the first state GREEN again, but remain RED.

Further, if the alarm controlled in step 311 is not the first alarm L1 coming from a particular camera, but comes from another camera being providing another, say a second alarm signal L2, L1 cannot be set to GREEN in step 312 because it was not the first alarm signal, but the second coming from different cameras.

A great advantage with this embodiment is that it facilitates for the operator of the surveillance system to focus on the surveillance without many disturbing false alarms, or even numerous disturbing true alarms, for one and the same event.

Another advantage of some of the embodiments presented herein is that they are simple to implement. For a person skilled in the art of programming by simple scripts for the VMS-server.

In the drawings and specification, there have been disclosed typical embodiments and, although specific terms are employed, they are used in a generic and descriptive sense only and not for purposes of limitation, the scope of the invention being set forth in the following claims.

1. An alarm handling device for handling alarms in a surveillance system, the alarm handling device comprising
an alarm evaluation and control unit having a first, second and third interface, and an alarm input signal control device wherein:
the first interface is configured to communicate and receive an alarm input signal from a surveillance detector device,
the second interface is configured to communicate with the alarm input signal control device arranged to control a state of the alarm signal having a first or a second state, wherein the alarm input signal control device is further arranged to provide an alarm to an operator thereof if the input alarm signal is in the first state, by setting the alarm signal to the second state, whereby the operator handles the alarm signal and a resulting clear alarm signal is arranged to be provided back to the alarm system control unit to reset the alarm signal to the first state.

2. The alarm handling device according to claim 1, wherein the operator can handle the alarm signal according to selectable levels.

3. The alarm handling device according to claim 2, wherein the selectable levels include accept, clear and create a state of the alarm signal.

4. A surveillance system, comprising at least one surveillance detector device, at least one surveillance display presenting surveillance information to an operator and an alarm handling device for handling alarms in the surveillance system, the alarm handling device comprising
an evaluation and control unit having a first, second and third interface, wherein:
the first interface is configured to receive an alarm input signal from said at least one surveillance detector device, wherein
the second interface is configured to communicate with an alarm input signal control device arranged to control a state of the alarm signal having a first or a second state, wherein the alarm input signal control device is further arranged to provide an alarm to an operator thereof if the input signal is in the first state, by setting the alarm signal to the second state, whereby the operator handles the alarm signal and a resulting clear alarm signal is arranged to be provided back to the evaluation and control unit to reset the alarm signal to the first state.

5. A method for handling alarms in a surveillance system which method comprises:
in an alarm control unit receiving an input from a surveillance detector device via a first interface,
communicating with an alarm input signal control device via a second interface,
controlling a state of the alarm signal having at least a first or a second state,
setting the alarm signal to the second state,
presenting an alarm to an operator thereof if the input signal is in the first state whereby the operator handles the alarm signal and a resulting clear alarm signal is sent back to the alarm evaluation and control unit to reset the alarm signal to the first state.
